(19) United States
(12) Patent Application Publication
(10) Pub. No.: US 2014/0242536 A1
(43) Pub. Date: Aug. 28, 2014

(54) MANDIBULAR ATTACHMENT FOR CORRECTION OF MALOCCLUSION

(71) Applicant: T. Richard Ziehmer, Tucson, AZ (US)

(72) Inventor: T. Richard Ziehmer, Tucson, AZ (US)

(21) Appl. No.: 13/777,866

(22) Filed: Feb. 26, 2013

(51) Int. Cl. A61C 7/36

(52) U.S. Cl. CPC A61C 7/36
USPC 433/19; 433/24

(57) ABSTRACT

Mandibular attachment structure, devoid of elastomeric member, for use in an orthodontic assembly having a force member connecting the mandibular and maxillar portions of the assembly and method of using the same. The structure includes bands dimensioned to encircle corresponding lower molars on opposite sides of the tongue, a single arched member connecting the bands and extending along a lingual side of the lower teeth, and threadless couplers each of which is affixed to a labial side of a corresponding band. Neither the structure nor the method require the use of an orthodontic brace to maintain a pressing connection between the structure and the rest of an orthodontic assembly. The pressing connection is maintained by cooperating a hook at the end of the force member and a hook at the end of a threadless coupler.

### TECHNICAL FIELD

The present invention is in the field of orthodontics and, more particularly, it relates to devices for correction of class II malocclusions.

### BACKGROUND ART

Orthodontics is a specialized field of dentistry that involves the application of mechanical forces to urge poorly positioned or crooked teeth into correct alignment and orientation. Orthodontic procedures can be used for cosmetic enhancement of teeth, as well as medically necessary movement of teeth. The orthodontic treatment of some patients includes correction of the alignment of the upper dental arch relative to the lower dental arch. Some patient have a condition referred to as Class II malocclusion or overjet, when the lower dental arch is located an excessive distance rearward of the upper dental arch when the jaws are closed. Other patients may have an opposite condition referred to as a Class III malocclusion (or negative overjet) when the lower dental arch is located forward of the upper dental arch when the jaws are closed.

Class II and Class III malocclusions may be corrected with the use of a head-gear (the effectiveness of which is almost entirely dependent on patient's compliance) or with a force-applying system such as an intraoral force module, for example. The force-applying system, when operably installed in the patient's mouth, enables the exertion of either a pulling force or a pushing force on the upper and lower jaws to which it is attached to move the jaws towards each other or away from each other.

Some known force-applying appliances are of complicated design and usually have a spring element that, in operation, require to be repositionably attached to an auxiliary component such as an orthodontic brace to effectuate a progressive jaw correction. Other appliances employ an elastomeric member rather than a spring element, the cooperation of which with a metallic structure attaching such element to the teeth via molding or adhesive may loose its strength over time. In yet another case, the rigid affixation between the maxillar and mandibular portions of an appliance requires the use of threads and/or pins and requires a labor-intensive initial placement on the teeth and is subject to breakage and increased treatment times. Therefore, while the advantageous use of an intraoral force module has been recognized, there are still opportunities for substantial improvements.

### SUMMARY

Embodiments of the present invention provide a method for using an orthodontic assembly that contains a maxillar attachment structure, a mandibular attachment structure, and a force member. The method includes (i) securing the mandibular attachment structure in removable cooperation with lower molar teeth of the patient, and (ii) pressingly connecting the maxillar and mandibular attachment structures by threadlessly cooperating the force member to a free proximal end to exert a force onto a lower molar tooth in a direction suitable to correct Class II malocclusion condition as the patient's mouth closes. The mandibular attachment structure has first and second bands each dimensioned to surround a corresponding lower molar tooth, a single arched member the ends of which are fixedly secured to posterior sides of the bands, and first and second connector portions each fixedly secured to an anterior surface of a corresponding band at a distal end and having a free proximal end. The single arched member is disposed on a posterior side of the lower teeth and wherein free distal ends of the first and second connector portions extend towards a middle of the patient's dental arch.

Embodiments of the present invention additionally provide a mandibular attachment structure for use in an orthodontic assembly, which includes first and second bands each dimensioned to surround a corresponding lower molar tooth; and a single arched member connected at its ends to first sides of the bands and extending, when operably installed in a patient's mouth, along a lingual side of the lower teeth. The first sides of the bands are associated with the lingual side of the lower teeth. The attachment structure additionally includes first and second threadless couplers, a first end of each of which is affixed to a labial side of a corresponding band. Each of the first and second threadless coupler extends along the single arched member, and the mandibular attachment structure is devoid of an orthodontic brace.

Embodiments of the present invention also provide an improvement to an orthodontic force module for use in correcting class II and/or class III malocclusions. The orthodontic force module at hand, which is devoid of an elastomeric member, has having a maxillar attachment structure affixable to two upper molar teeth with the use of upper crown bands each substantially encircling a crown of a corresponding upper molar tooth, two lower crown bands each substantially encircling a crown of a corresponding lower molar tooth. The module also includes a coupling member enabling, in operation, a forced connection between the maxillar attachment structure and the two lower crown bands. The improvement includes a single arched member secured at its end to lingual sides of the lower crown bands, where the single arched member has a retainer clasp that enables, in operation, engagement of a premolar tooth at a lingual side thereof when the so connected single arched member is operably installed in the patient's mouth. The improvement additionally includes first and second connector portions each secured to a labial surface of a corresponding lower crown band at a distal end and having a proximal end that is enabled to threadlessly cooperate with the coupling member such that a force, created through the forced connection between the maxillar attachment structure and a lower crown band, is not applied to an orthodontic brace.

### BRIEF DESCRIPTION OF THE DRAWINGS

The invention will be more fully understood by referring to the following Detailed Description of Specific Embodiments in conjunction with the Drawings, of which:

FIGS. 1A and 1B are diagrams illustrating Class II malocclusion and Class I normal occlusion.

FIGS. 2A, 2B, and 2C are diagrams illustrating schematically a structure and cooperation of portions of M.A.R.A. orthodontic appliance.

FIGS. 3A, 3B are diagrams illustrating schematically a structure and cooperation of portions of Forsus orthodontic appliance.

FIGS. 4A, 4B, 4C, and 4D are diagrams illustrating schematically a structure and cooperation of portion of an orthodontic appliance according to an embodiment of the invention.

### DETAILED DESCRIPTION

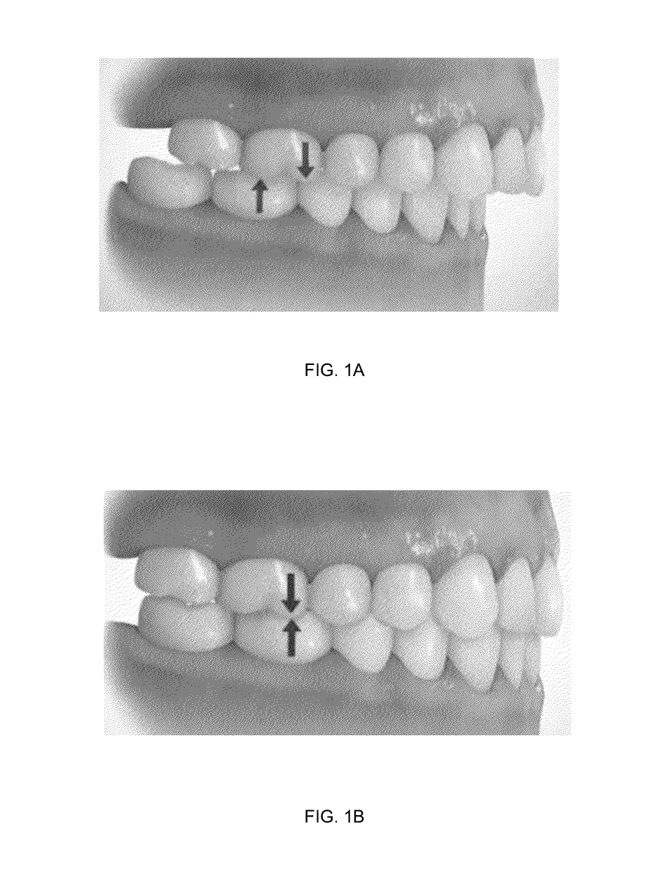

Class II malocclusion occurs in approximately 33% of the general population in the United States and presents a challenge for the orthodontist. In reference to FIG. 1A, Class II malocclusion occurs when the lower jaw is deficient in length and sits behind the upper jaw. Not only can this compromise proper function, but often times can be a contributing factor to a less attractive smile and profile appearance. FIG. 1B presents, for comparison, a depiction of normal occlusion (Class I). Historically, a Class II occlusion has been treated effectively with headgear appliances that are best utilized when a patient is a still-growing child. The conventional headgear serves to maintain the position of the upper jaw while the lower jaw expresses its natural growth in a forward direction, and therefore correcting the occlusion. However, the downside of the headgear appliance is that it is unattractive, and its success is entirely dependent upon patient compliance; something that has been and continues to be an ongoing problem in orthodontics.

The intra-oral force-applying appliances of related art used as alternatives to head gear have certain limitations. For example, many such devices are of complex design, requiring a number of moving parts (such as pins, for example), and cannot be easily installed in the correct location in a patient's mouth. Additionally, many intra-oral devices for occlusion correction are not easily adaptable to being employed during the period of growth spurts of the patient (ranging anywhere from as early as 8.5 years in females to as late as 14 years in males) in either the mixed dentition or permanent dentition periods. Many such devices, for example, require permanent dentition prior to installation, at which point much of a patient's growth is already over, which limits the efficacy of the devices.

Additionally, for proper operation such intra-oral orthodontic appliances should be configured to be independent from the usage of orthodontic braces and to enable the malocclusion correction with or without orthodontic braces placed on the patient's teeth. The orthodontic brackets and wires, which together are commonly referred to as “braces”, include small slotted bodies configured to be directly attached to the patient's teeth or, alternatively, to be attached to bands which are, in turn, cemented or otherwise secured around the teeth. Once the brackets are affixed to the patient's teeth, a curved wire is inserted into the bracket slots. The brackets and the arch wire cooperate to guide corrective movement of the teeth into proper alignment. Typical corrective movement provided by the braces include torque, rotation, and leveling of the teeth. An example of orthodontic appliance that cannot be used at the same time when a patient wears orthodontic braces prescribed by the dentist is provided by the so-called Higgins Crossbow appliance that requires the use of two arched members one of which is extended along the labial side of the teeth where an orthodontic bracket would be placed. Other appliance, such as the Forsus appliance, discussed in more detail below, require the installation of braces for use.

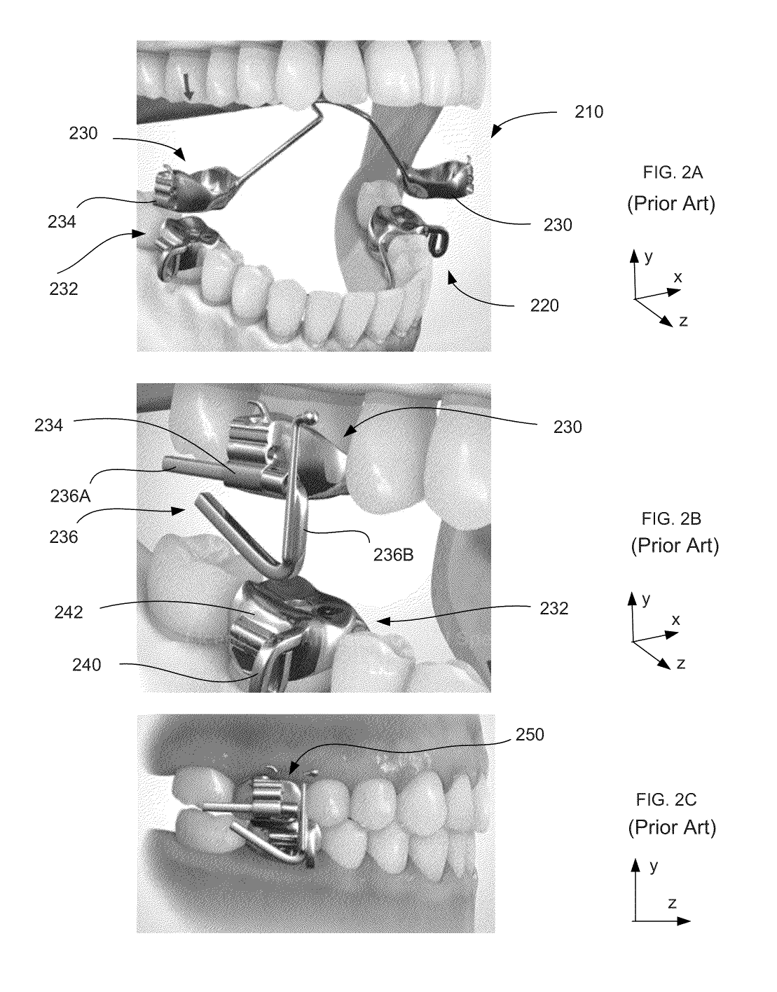

To illustrate some devices of related art, FIGS. 2A, 2B and 2C provide diagrams of components of the M.A.R.A. appliance, showing the maxillar and mandibular portions 210, 220 fixed on molar teeth of the upper and lower molar teeth, respectively, with crowns 230, 232. While FIGS. 2A, 2B offer perspective views of the appliance attached to teeth in the open mouth of the patient, FIG. 2C illustrates a substantially side view of the mouth that is equipped with the appliance and the jaws of which are closed. To form a connection between the upper and lower jaws, when the patient's mouth is closed, the crown 230 of the maxillar portion 210 is equipped with a tube bracket 234 that is dimensioned to removably accept a pin 236 having a first portion 236A insertable into a hollow of the bracket 234 and a second portion 236B extended transversely to the first portion 236A. The crown 232 of the mandibular portion 220, in turn, is fixedly equipped with a stopper 240 extending and defined in a surface (substantially corresponding to the xy-plane of FIG. 2C) that is transverse to a labial surface 242 of the crown 232 to provide support to which, as shown in FIG. 2C, the second portion 236B of the pin 236 is pressed and against which the second portion 236B applies force in operation. While this appliance can be employed in the mixed or permanent dentition and with or without braced placed on the teeth, the outward extension of the stopper 240 from a tooth toward a lip of the mouth and a need to secure the pin 236 in a tube bracket 234 (for example with a rubber band 250, as shown in FIG. 2C) unnecessarily complicate its practical use.

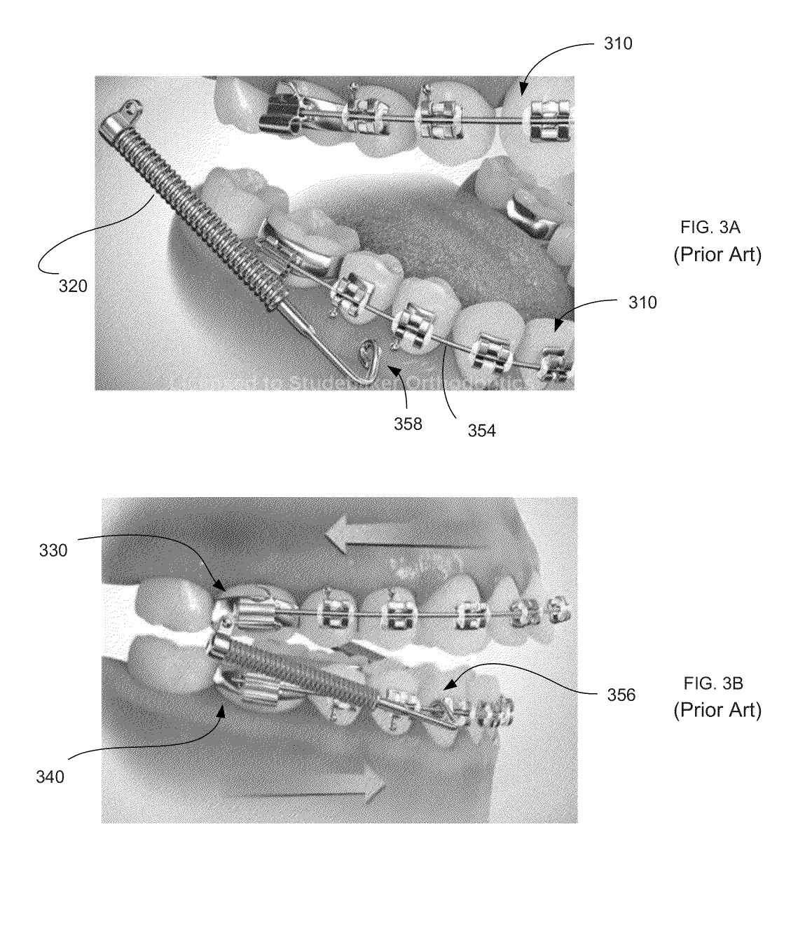

The Forsus appliance, illustrated in diagrams of FIGS. 3A, 3B can only be used when the patient has all of his or her permanent teeth erupted and braces 310 are placed on all teeth. As shown in FIG. 3B, the spring member 320 that connects the maxillar and mandibular portions 330, 340 of the Forsus appliance, requires affixation to a wire 354 of the orthodontic brace 310 at least at one end. As shown at 356, such affixation is achieved with the use of a hook or loop 358 formed at an end of the member 320, which slides along the wire 354. (While the spring member 320 is illustrated as a coil spring, a related (not shown) structure may employ a leaf-spring or a spring structured as a bent rod.) A significant number of patients are well past their growth spurt by the time all upper and lower permanent teeth have erupted, thus limiting the amount of skeletal correction that can be achieved and rendering the current model of the Forsus appliance not particularly effective for many patients. Additionally, in operation hook or loop 358 formed at the end of member 320 of the Forsus appliance exerts force on at least one bracket of the brace 310 to which it is affixed. As a result, breakage or loss of adhesion of the brace brackets is common with the Forsus appliance, which requires frequent office visits to repair.

Embodiments of the present invention provides an orthodontic appliance that alleviates the above-identified problems and limitations of operation and enables the Class II and/or Class III malocclusion correction during the mixed dentition phase, without reliance on, or damage to, an orthodontic brace.

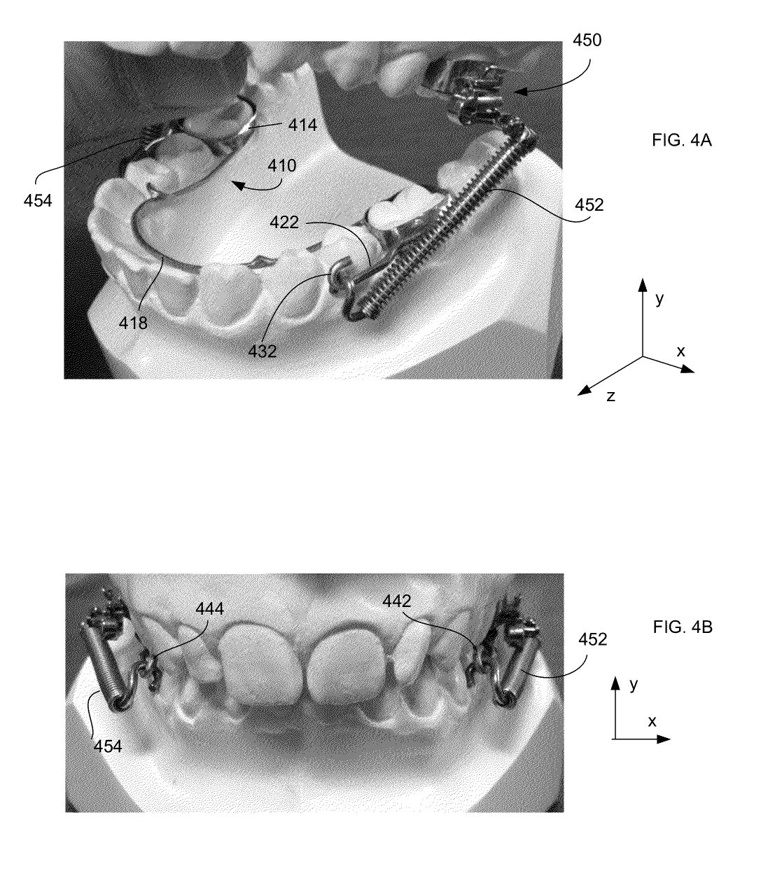

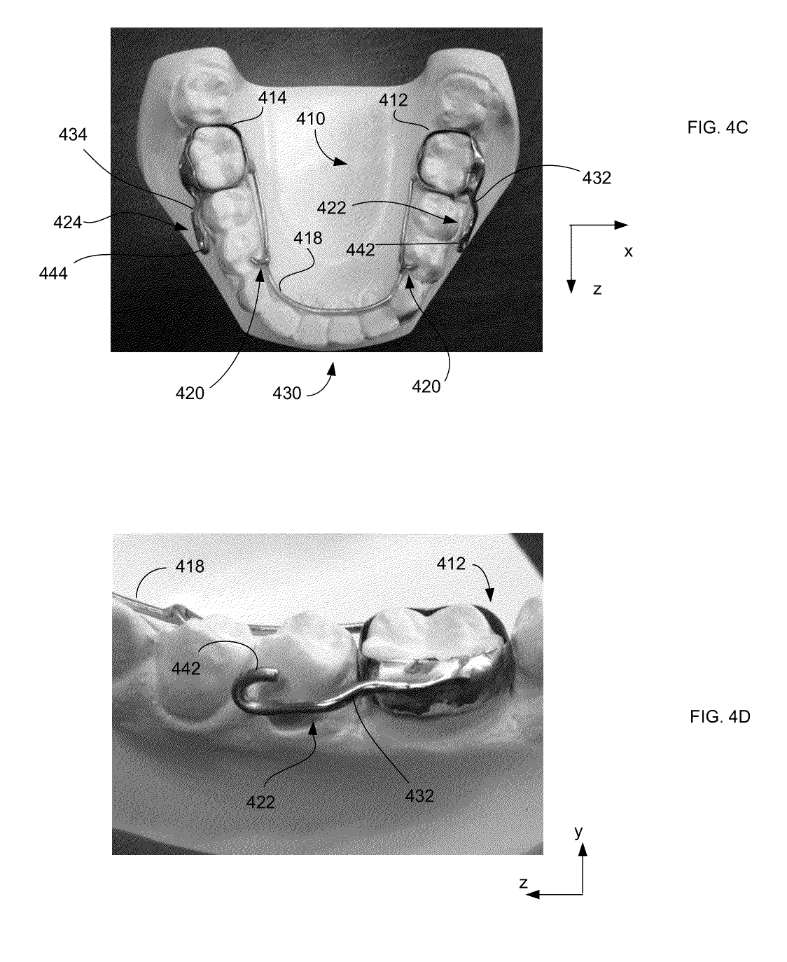

Referring now to FIGS. 4A through 4D, an embodiment of the invention includes a mandibular attachment structure 410 that is devoid of elastomeric material and that is affixable to the first and second lower molar teeth with the use of bands 412, 414, each of which is appropriately dimensioned to surround a corresponding lower molar tooth. According to the idea of the invention, the interconnection of the bands 412, 414 is configured on only the lingual side of the embodiment. Accordingly, the bands 412, 414 are linked with a single arched member 418 (made, in one implementation of a wire) the ends of which are securely affixed to anterior, lingual sides of the bands 412, 414. The arched member may optionally be equipped with at least one (as shown—two) retainer clasp 420 that, in operation (when the embodiment is installed into a patient's mouth), enables the engagement between the arched member 418 and a premolar tooth on its lingual side. To a labial side of each of the bands 412, 414 a corresponding connector or coupler 422, 424 is secured (for example, by soldering) that is extended along a corresponding jaw toward the middle of the patient's dental arch (labeled as 430). Portions of the connectors 422, 424 that are distal to the bands 412, 414 may be transversely offset from the bands by offset sections 432, 434, and are terminated with attachment means that are devoid of threads, such as, for example, hooks 442, 444.

The embodiment of the invention may additionally include a maxillar attachment structure 450 containing a band affixing the maxillar structure to an upper molar tooth. The embodiment may further include force member(s) 452, 454 (including, for example, a coil or leaf or rod spring) configured to be affixable to the maxillar attachment structure 450 (through, for example, a pin or clasp fitting to an appropriate receiving portion of the maxillar attachment structure such as a tube bracket or a hook) at one end and threadlessly and pinlessly cooperating with the attachment means 442, 444 of the mandibular structure 410. In operation, when both the mandibular structure 410 and the maxillar structure 450 are installed in the patient's mouth and connected to the force member(s) 452, 454, and when the patient closes his jaws, the force member(s) 452, 454 pressingly connect the structures 410 and 450 to exert a force on lower molar teeth (through the couplers 422, 432 and the bands 412, 414) in a direction suitable to correct Class II or Class III malocclusions. The force applied to the lower jaw is progressively adjustable by adjusting the tension in the force member(s) 454. In contradistinction with devices of the related art, such transfer of force does not require the presence and/or use of orthodontic braces and can be used contemporaneously with the use of these braces or at a time when the braces are not prescribed. Moreover, the fact that the attachment elements 442, 444 of the mandibular structure 410 are devoid of protrusions or excursions that are transverse to the labial side of the brackets 412, 414 improves patient's comfort in wearing such orthodontic appliance, as compared to the M.A.R.S. appliance, for example.

In one implementation, the mandibular portion 410 of the article of the invention can be used as an attachment for the Forsus arms of a portion of the Forsus appliance during the mixed dentition, thereby increasing the effectiveness of the Forsus appliance and extending its use to a greater number of patients. The method for using an orthodontic assembly according to an embodiment of the invention includes securing the mandibular attachment structure of the invention in removable cooperation with lower molar teeth of the patient such as to surround these teeth with first and second bands 412, 414 of the mandibular structure, to place the arched member 418 of the lingual side of the lower teeth and to position the connector or couplers 422, 432 on the labial side of the lower teeth with the hooks 442, 454 extensing towards the middle 430 of the dental arch of the patient.

While the invention is described through the above-described exemplary embodiments, it will be understood by those of ordinary skill in the art that modifications to, and variations of, the illustrated embodiments may be made without departing from the inventive concepts disclosed herein. Furthermore, disclosed aspects, or portions of these aspects, may be combined in ways not listed above. Accordingly, the invention should not be viewed as being limited to the disclosed embodiment(s).

1. A method for using an orthodontic assembly including a maxillar attachment structure, a mandibular attachment structure, and a force member, the method comprising:
securing the mandibular attachment structure in removable cooperation with lower molar teeth of the patient,
the mandibular attachment structure having first and second bands each dimensioned to surround a corresponding lower molar tooth, a single arched member the ends of which are fixedly secured to lingual sides of said bands, and first and second connector portions each fixedly secured to a buccal surface of a corresponding band at a distal end and having a free mesial end,
wherein the single arched member is disposed on a lingual side of the lower teeth and wherein free mesial ends of the first and second connector portions extend towards a middle of the patient's dental arch and
pressingly connecting the maxillar and mandibular attachment structures by threadlessly cooperating the force member to a free mesial end to exert a force onto a lower molar tooth in a direction suitable to correct Class II malocclusion condition as the patient's mouth closes.

2. A method according to claim 1, further comprising maintaining the pressing connection between the maxillar and mandibular attachment structures without the use of an orthodontic brace.

3. A method according to claim 1, wherein the mandibular attachment structure is devoid of an elastomeric member.

4. A method according to claim 1, wherein the securing includes cooperating a retainer clasp attached to the single arched member with a posterior portion of a premolar tooth.

5. A method according to claim 1, wherein a free mesial end is bent to form an attachment hook and wherein the pressingly connecting includes cooperating a hook at the end of the force member with the attachment hook.

6. A method according to claim 1, wherein the hooks of the first and second connector portions are formed in planes extending substantially along anterior surfaces of the first and second bands.

7. A method according to claim 1, wherein, the maxillar attachment structure comprises a spring loaded telescoping rod.

8. A mandibular attachment structure for use in an orthodontic assembly, the structure comprising:
first and second bands each dimensioned to surround a corresponding lower molar tooth;
a single arched member connected at its ends to first sides of said bands and extending, when operably installed in a patient's mouth, along a lingual side of the lower teeth, the first sides of the bands associated with the lingual side of the lower teeth; and
first and second threadless couplers, each coupler including a free end, a first end of each of the first and second threadless couplers affixed to a labial side of a corresponding band, each of the first and second threadless coupler extending along the single arched member,
wherein the mandibular attachment structure is devoid of an orthodontic brace.

9. A mandibular attachment structure according to claim 8, wherein a threadless coupler includes a hook at a second end thereof

10. A mandibular attachment structure according to claim 8, further comprising a retainer clasp affixed to the single arched member to engage a lingual side of a premolar tooth when the mandibular attachment structure is operably installed in the patient's mouth.

11. An orthodontic assembly including a mandibular attachment structure according to claim 8, and further comprising
a maxillar attachment structure, and
a connecting member having a first means enabling a pinless operable connection between the connecting member and the mandibular attachment structure and a second means enabling operable connection between the connecting member and the maxillar attachment structure such as to exert a force onto a lower molar tooth in a direction suitable to correct the Class II malocclusion condition as the patient's mouth closes.

12. In an orthodontic force module for use in correcting class II malocclusions and having a maxillar attachment structure affixable to two upper molar teeth with the use of upper crown bands each substantially encircling a crown of a corresponding upper molar tooth, two lower crown bands each substantially encircling a crown of a corresponding lower molar tooth, and a coupling member enabling, in operation, a forced connection between the maxillar attachment structure and the two lower crown bands, the orthodontic force module being devoid of an elastomeric member, the improvement comprising
a single arched member secured at its end to lingual sides of the lower crown bands, said single arched member having a retainer clasp that enables, in operation, engagement of a premolar tooth at a lingual side thereof when the so connected single arched member is operably installed in the patient's mouth; and
first and second connector portions each secured to a labial surface of a corresponding lower crown band at a distal end and having a mesial free end that is enabled to threadlessly cooperate with the coupling member such that a force, created through the forced connection between the maxillar attachment structure and a lower crown band, is not applied to an orthodontic brace.
